(19) United States
(12) Patent Application Publication
(10) Pub. No.: US 2025/0165828 A1
(43) Pub. Date: May 22, 2025

(54) CLASSICAL SIMULATION OF A QUANTUM SYSTEM

(71) Applicant: IQM FINLAND OY, Espoo (FI)

(72) Inventors: Akseli MÄKINEN, Espoo (FI); Joni IKONEN, Espoo (FI); Jani TUORILA, Espoo (FI); Mikko MÖTTÖNEN, Espoo (FI)

(21) Appl. No.: 18/840,252

(22) PCT Filed: Feb. 21, 2022
(86) PCT No.: PCT/EP2022/054202

§ 371 Date: Aug. 21, 2024

(51) Int. Cl. G06N 10/20

(52) U.S. Cl. CPC G06N 10/20

(57) ABSTRACT

According to an example embodiment, a method (100) for simulating a quantum operator of a bosonic quantum system is provided, the method (100) comprising: obtaining (102) a first representation that defines the quantum operator in a first operator basis using a first sequence of expansion coefficients; transforming (104), via applying a first transformation on the first sequence of expansion coefficients, the first representation into a second representation that defines the quantum operator in a first function basis using a second sequence of expansion coefficients; decomposing (106) the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients; determining (108) time-evolved values of the third sequence of expansion coefficients based on the third representation, thereby determining time-evolved independent sets of functions represented in the second function bases; and determining (110) time-evolved values of the first sequence of expansion coefficients via applying a second transformation on the second sequence of expansion coefficients and on the time-evolved third sequence of expansion coefficients to determine the time-evolved quantum operator in a second operator basis.

### TECHNICAL FIELD

The example and non-limiting embodiments of the present invention relate to simulation of a quantum system using one or more classical computers and, in particular, simulation of an open bosonic quantum system using one or more classical computers.

### BACKGROUND

In recent years, the potential to provide disruptive advances in fields such as finance, pharmacy and cybersecurity has driven fast development of quantum computers. Usage of one or more classical computers to simulate a quantum processor implementing a certain quantum algorithm constitutes an important tool for development of quantum processors and quantum algorithms. Simulations of a quantum computer implementing a quantum algorithm using one or more classical computers, i.e. classical simulations, enable e.g. the following advantages:
An accurate classical simulation enables optimization of the control of the quantum processor to seek maximal accuracy in performing the quantum algorithm under consideration;
A verification of operation of the quantum processor and/or the quantum algorithm in view of potential or claimed quantum supremacy in a fully controllable processing environment;
A proof of claimed or assumed quantum supremacy in a fully controllable processing environment.

Some of the most prominent architectures for programmable quantum computers are based on superconducting technology. Such devices, as well as ones employing quantum optics or circuit quantum electrodynamics, may be considered as bosonic systems. Due to the requirement of control and high density of physical elements therein, such systems are intrinsically subject to environmental noise, i.e. open, and, consequently, classical simulations constitute an important tool both for optimizing control of the quantum processor for maximal accuracy in performing the quantum algorithm it serves to implement and for verifying the operation and/or proving the performance of the quantum algorithm implemented by the quantum processor.

However, previously known methods for classical simulation of quantum processor and/or quantum algorithms in context of open bosonic quantum systems are limited in their capability of modeling increasingly complex quantum algorithms and/or require unfeasibly long simulation time.

### SUMMARY

It is an object of the present invention to provide a technique for simulating an open bosonic quantum system e.g. implementing a quantum algorithm of high complexity via operation of one or more classical computers.

According to an example embodiment, a method for simulating a quantum operator of a bosonic quantum system is provided, the method comprising: obtaining a first representation that defines the quantum operator in a first operator basis using a first sequence of expansion coefficients; transforming, via applying a first transformation on the first sequence of expansion coefficients, the first representation into a second representation that defines the quantum operator in a first function basis using a second sequence of expansion coefficients; decomposing the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients; determining time-evolved values of the third sequence of expansion coefficients based on the third representation, thereby determining time-evolved independent sets of functions represented in the second function bases; and determining time-evolved values of the first sequence of expansion coefficients via applying a second transformation on the second sequence of expansion coefficients and on the time-evolved third sequence of expansion coefficients to determine the time-evolved quantum operator in a second operator basis.

According to another example embodiment, a method for simulating a quantum operator of a bosonic quantum system is provided, the method comprising: obtaining a first representation that defines the quantum operator in a first operator basis using a first sequence of expansion coefficients; transforming, via applying a first transformation on the first sequence of expansion coefficients, the first representation into a second representation that defines the quantum operator in a first function basis using a second sequence of expansion coefficients; decomposing the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients; and determining time-evolved values of the third sequence of expansion coefficients based on the third representation, thereby determining time-evolved independent sets of functions represented in the second function bases.

According to another example embodiment, a method for simulating a quantum operator of a bosonic quantum system is provided, the method comprising: receiving respective values of time-evolved values of a second sequence of expansion coefficients and a third sequence of expansion coefficients, wherein said time-evolved values of the third sequence of expansion coefficients are determined based on a third representation of a quantum operator that is obtained via decomposing a second representation of the quantum operator into the third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using the third sequence of expansion coefficients, and wherein the second representation defines the quantum operator in a first function basis using the second sequence of expansion coefficients, wherein the second representation is obtained via applying a first transformation on a first sequence of expansion coefficients of a first representation of the quantum operator that defines the quantum operator in a first operator basis using the first sequence of expansion coefficients; and determining time-evolved values of the first sequence of expansion coefficients via applying a second transformation on the second sequence of expansion coefficients and on the time-evolved third sequence of expansion coefficients to determine the time-evolved quantum operator in a second operator basis.

According to another example embodiment, an apparatus for simulating a quantum operator of a bosonic quantum system is provided, the apparatus comprising at least one processor and at least one memory including computer program code for one or more computer programs, wherein the at least one memory and the computer program code are configured to, with the at least one processor, cause the apparatus to perform the method according to

[symbol]

According to another example embodiment, a system is provided, the system comprising: an encoder arranged to: obtain a first representation that defines the quantum operator in a first operator basis using a first sequence of expansion coefficients, transform, via applying a first transformation on the first sequence of expansion coefficients, the first representation into a second representation that defines the quantum operator in a first function basis using a second sequence of expansion coefficients, and decompose the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients; a simulator arranged to determine time-evolved values of the third sequence of expansion coefficients based on the third representation, thereby determining time-evolved independent sets of functions represented in the second function bases; and a decoder arranged to determine time-evolved values of the first sequence of expansion coefficients via applying a second transformation on the second sequence of expansion coefficients and on the time-evolved third sequence of expansion coefficients to determine the time-evolved quantum operator in a second operator basis.

According to another example embodiment, an encoder apparatus is provided the encoder apparatus comprising: an encoder arranged to: obtain a first representation that defines the quantum operator in a first operator basis using a first sequence of expansion coefficients, transform, via applying a first transformation on the first sequence of expansion coefficients, the first representation into a second representation that defines the quantum operator in a first function basis using a second sequence of expansion coefficients, and decompose the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients; a simulator arranged to determine time-evolved values of the third sequence of expansion coefficients based on the third representation, thereby determining time-evolved independent sets of functions represented in the second function bases; and a communication portion arranged to transmit the second sequence of expansion coefficients and the time-evolved values of the third sequence of expansion coefficients to another apparatus.

According to another example embodiment, a decoder apparatus is provided, the decoder apparatus comprising: a communication portion for receiving, from another apparatus, respective values of a second sequence of expansion coefficients and time-evolved values of a third sequence of expansion coefficients, wherein said time-evolved values of the third sequence of expansion coefficients are determined based on a third representation of a quantum operator that is obtained via decomposing a second representation of the quantum operator into the third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using the third sequence of expansion coefficients, and wherein the second representation defines the quantum operator in a first function basis using the second sequence of expansion coefficients, wherein the second representation is obtained via applying a first transformation on a first sequence of expansion coefficients of a first representation of the quantum operator that defines the quantum operator in a first operator basis using the first sequence of expansion coefficients; and a decoder arranged to determine time-evolved values of the first sequence of expansion coefficients via applying a second transformation on the second sequence of expansion coefficients and on the time-evolved third sequence of expansion coefficients to determine the time-evolved quantum operator in a second operator basis.

According to another example embodiment, a computer program for simulating a quantum operator of a bosonic quantum system is provided, the computer program comprising computer instructions for causing one or more apparatuses to perform one of the methods described in the foregoing.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatus(es) at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 depicts a block diagram that illustrates a simulation technique according to an example;

FIG. 2 illustrates a method according to an example;

FIG. 3A depicts a block diagram that illustrates a simulation technique according to an example;

FIG. 3B depicts a block diagram that illustrates a simulation technique according to an example; and

FIG. 4 illustrates a block diagram of some components of an apparatus according to an example.

### DESCRIPTION OF SOME EMBODIMENTS

The present disclosure describes a technique for simulating one or more aspects of a bosonic quantum system, such as a quantum computer based on superconducting technology, on quantum optics or on circuit quantum electrodynamics, whereas the simulation may be carried out using one or more classical computers. As discussed above, such a simulation may be referred to as a classical simulation. In this regard, the simulation may concern the bosonic quantum system arranged for implementing a quantum algorithm of interest, and the simulation may be carried out in the Heisenberg picture of quantum mechanics characterized by a Hamiltonian Ĥ(t) and a system operator Â(t), where the simulation may rely on simulation of dynamics of the system operator Â(t). In the following, the system operator Â(t) is referred to as a respective quantum operator Â(t).

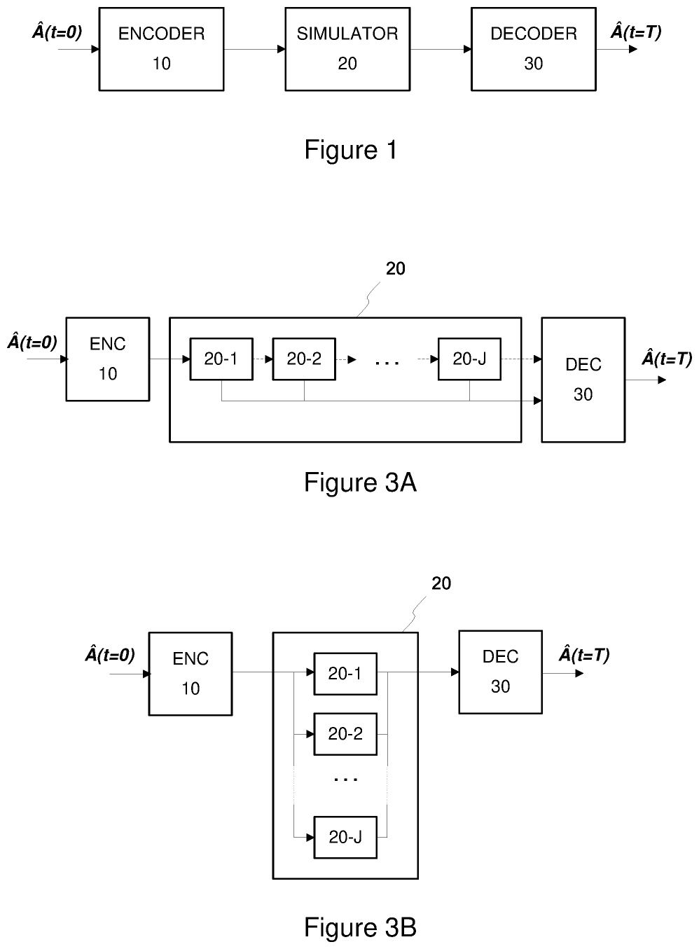

A high level operation of the disclosed simulation technique is illustrated via a block diagram depicted in FIG. 1: an encoder 10 may be applied to encode an original representation of a quantum operator Â(t) under consideration into two or more encoded components that may be simulated independently of each other, thereby allowing for simulation of the quantum operator Â(t) at a significantly reduced computational complexity, a simulator 20 may be applied to carry out the simulation of the quantum operator Â(t) based on the two or more encoded components via simulating them separately from each other, and a decoder 30 may be applied to decode the simulated encoded components back to the original representation or to another predefined representation. Since the simulation may be carried out based on the two or more encoded components, the simulator 20 may be also referred to as an encoded domain simulator 20.

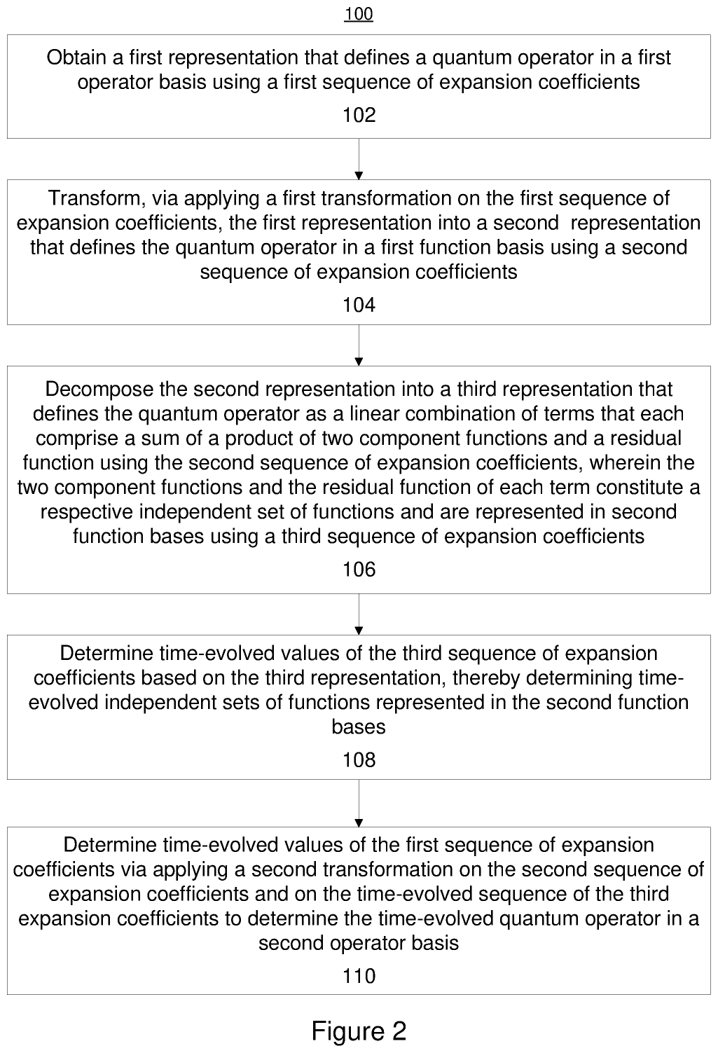

FIG. 2 illustrates a block diagram that represents at least some steps of a method 100 that is applicable for carrying out the simulation using the model outlined in FIG. 1 in order to simulate dynamics of the quantum operator Â(t). Herein, the term dynamics refers to evolution of the quantum operator Â(t) and/or functions applied to represent the quantum operator Â(t) as a function of time. The method 100 may comprise the following steps:
obtaining a first representation that defines the quantum operator Â(t) in a first operator basis using a first sequence of expansion coefficients, as indicated in block 102;
transforming, via applying a predefined first transformation on the first sequence of expansion coefficients, the first representation into a second representation that defines the quantum operator Â(t) in a first function basis using a second sequence of expansion coefficients, as indicated in block 104;
decomposing the second representation into a third representation that defines the quantum operator Â(t) as a linear combination of terms that each comprise a sum of a product of two component functions and a residual function using the second sequence of expansion coefficients such that the two component functions and the residual function of each term constitute a respective independent set of functions and are represented in second function bases using a third sequence of expansion coefficients, as indicated in block 106;
determining time-evolved values of the third sequence of expansion coefficients based on the third representation, thereby determining time-evolved independent sets of functions represented in the second function bases, as indicated in block 108; and
determining time-evolved values of the first sequence of expansion coefficients via applying a predefined second transformation on the second sequence of expansion coefficients and on the time-evolved third sequence of expansion coefficients to determine the time-evolved quantum operator Â(t) in a second operator basis, as indicated in block 110.

In the above description of the method 100, operations that pertain to blocks from 102 to 106 may be considered as encoding of the quantum operator Â(t) and these operations may be carried out by the encoder 10, operations that pertain to block 108 may be considered as (encoded domain) simulation of the quantum operator Â(t) in the encoded domain and these operations may be carried out by the simulator 20, whereas operations that pertain to block 110 may be considered as decoding the (encoded) quantum operator Â(t) and these operations may be carried out by the decoder 30. In this regard, it is worth noting that the two component functions and the residual function of each term (cf. block 106) jointly constitute a respective set of functions having respective time evolution that is independent of other sets of functions, thereby enabling the aspect of carrying out the simulation based on two or more encoded components via determination of the time-evolved values of the third sequence of expansion coefficients in order to determine the time-evolved independent sets of functions (cf. block 108). In the following, respective operations of each of the blocks from 102 to 110 are described in more detail via respective non-limiting examples. For brevity and clarity of description, these operations are described predominantly in the framework of a scenario where the bosonic quantum system under consideration contains only one mode. In other words, the following examples predominantly describe the method 200 in context of a bosonic quantum system that includes a single subsystem.

As a background for operations pertaining to block 102, the Hamiltonian Ĥ(t) of the underlying bosonic quantum system may be expanded in the first operator basis, for example, as

$$\hat{H} ( t ) / h = {\sum }_{k , l = 0}^{∞} {h}_{k , l} ( t ) {\hat{o}}_{1}^{k} {\hat{o}}_{2}^{l} , \qquad ( 1 )$$

where ô₁ and ô₂ denote elementary operators of the first operator basis. In this regard, the elementary operators ô₁ and ô₂ conform to the following conditions:
the elementary operators ô₁ and ô₂ conform to the commutation relation [ô₁, ô₂^{l}]=rÎ, where r∈ [symbol] \{0} and Î is the identity operator;
monomials {ô₁^{k}ô₂^{l}}_{k,l=0}^{∞} of the elementary operators ô₁ and ô₂ form a complete operator basis.

Along similar lines, the initial value of the quantum operator Â(t=0) of the underlying bosonic quantum system may be expanded in the first operator basis, for example as,

$$\hat{A} ( t = 0 ) = {\sum }_{k , l = 0}^{∞} {f}_{k , l} ( t = 0 ) {\hat{o}}_{1}^{k} {\hat{o}}_{2}^{l} , \qquad ( 2 )$$

where f_{k,l}(t=0) denote expansion coefficients that define the quantum operator Â(t=0) based on monomials of the elementary operators ô₁ and ô₂. This enables representing the quantum operator under consideration at the time instant t=0 in the first operator basis (cf. block 102), which may be referred to as the first representation of the quantum operator in context of the present disclosure. Hence, the first representation defines the quantum operator Â(t=0) in the first operator basis via usage of the expansion coefficients f_{k,l}(t=0).

As a background for operations pertaining to block 104, a generic adjoint master equation of the bosonic quantum system under consideration may be expressed, for example, as

$$\frac{d \hat{A} ( t )}{dt} = \frac{i}{h} [ \hat{H} ( t ) , \hat{A} ( t ) ] + {\sum }_{n} \frac{{κ}_{n}}{2} [ 2 {\hat{L}}_{n}^{†} \hat{A} ( t ) {\hat{L}}_{n} - \{ {\hat{L}}_{n}^{†} {\hat{L}}_{n} , \hat{A} ( t ) \} ] , \qquad ( 3 )$$

where \hat{L}ₙ denotes the Lindblad jump operator of the noise channel n and where {Ô₁, Ô₂}=Ô₁Ô₂+Ô₂Ô₁ denotes the anticommutator.

The equation (3) may be mapped into a complex-valued partial differential equation, for example, via inserting the equations (1) and (2) into the equation (3) and via further defining a first generating function F(x, y; t=0) that is applicable for generating the first sequence of expansion coefficients of the quantum operator Â(t=0). In this regard, the first generating function F (x, y; t=0) may be a complex-valued one and it may be defined, for example, as

$$F ( x , y ; t = 0 ) = {\sum }_{k , l = 0}^{∞} {f}_{k , l} ( t = 0 ) {x}^{k} {y}^{l} . \qquad ( 4 )$$

The function basis of the representation according to the equation (4) may be regarded as a classical equivalent of the first operator basis, whereas the equation (4) may be considered as a map of the first representation of the quantum operator Â(t =0) according to the equation (2) to the second representation that defines the quantum operator \hat{Â}(t=0) in a first function basis using the first sequence of expansion coefficients f_{k,l}(t=0).

Consequently, a dynamic equation that yields the dynamics of the generating function F(x, y; t) may read as

$$\frac{dF ( x , y ; t )}{dt} = i [ : H ( x , r {\partial }_{x} + y ; t ) : - : H ( x + r {\partial }_{y} , y ; t ) : ] F ( x , y ; t ) + {\sum }_{n} {κ}_{n} {O}_{n} ( x , {\partial }_{x} , y , {\partial }_{y} , r ) F ( x , y ; t ) , \qquad ( 5 )$$

where :*: denotes ordering of the variables to the left with respect to the differentiation operators, H(x, y; t)=Σ_{u,v=0}^{∞}h_{u,v}(t)x^{u}y^{v}, and Oₙ represents a multivariate function of the coordinates and the differential operators associated with the noise channel n. It is worth noting that herein the choice of the function basis in the definition of the first generating function F(x, y; t=0) may be substantially arbitrary and a different choice of function basis would lead into a different form of the dynamic equation (5). The first generating function F(x, y; t=0) may be also referred to as a classical function.

Furthermore, the dynamic equation that indirectly yields the dynamics of the quantum operator Â(t=0) via the second representation of the quantum operator Â(t=0) in the first function basis yields the dynamics of a function of multiple non-temporal variables (e.g. a function of two non-temporal variables, according to the equation (5) above). While such a function is basically solvable via application of numerical methods known in the art, using numerical methods to solve such a function of multiple non-temporal variables typically leads to a high computational load e.g. due to excessive memory and/or processing power requirements, thereby in many scenarios rendering its solution via usage of one or more classical computers infeasible or even virtually impossible. In the following, a function of multiple non-temporal variables may be referred to as a multivariate function, while a function of two non-temporal variables (that serves as an example of a multivariate function) may be referred to as a bivariate function. In contrast a function of a single non-temporal variable may be referred to as a univariate function.

The aspect of transforming the second representation of the quantum operator Â(t=0) into its second representation may be carried out via applying the first transformation on the first generating function F(x, y; t=0). As an example, the first transformation to be applied on the on the first generating function F(x, y; t=0) may be the following:

$$G ( x , y ; t = 0 ) = {e}^{{r}^{- 1} xy} F ( x , y ; t = 0 ) . \qquad ( 6 )$$

The transformation according to the equation (6) above may be referred to, for example, as a scaling transformation due to its characteristics of scaling the function under transformation. In other examples, a transformation different from that defined by the equation (6) may be applied as the first transformation, e.g. any other automorphism.

In this regard, the second representation still defines the quantum operator Â(t=0) in the first function basis, whereas the transformation may be implemented by applying the transformation on the first sequence of expansion coefficients to generate the second sequence of expansion coefficients. The transformation according to the equation (6) results in transforming the dynamic equation according to the equation (5) that yields the dynamics of the first generating function F(x, y; t) into a transformed dynamic equation that yields the dynamics of the second generating function G(x, y; t) as

$$\frac{dG ( x , y ; t )}{dt} = i [ : H ( x , r {\partial }_{x} ; t ) : - : H ( r {\partial }_{y} , y ; t ) : ] G ( x , y ; t ) + {\sum }_{n} {κ}_{n} {O}_{n}^{′} ( x , {\partial }_{x} , y , {\partial }_{y} , r ) G ( x , y ; t ) , \qquad ( 7 )$$

where O′ₙ=e^{r}^{^{−1}}^{xy}Oₙe^{-r}^{^{−1}}^{xy}. Along the lines described in the foregoing, the dynamic equation according to the equation (7) above is a non-limiting example that depends on the choice of the function basis in the definition of the first generating function F(x, y; t) and on the first transformation according to the equation (6), whereas a different choice of the function basis and/or the first transformation would lead into a different form of the dynamic equation (7).

The second generating function G(x, y; t=0) may be approximated as

$$G ( x , y ; t = 0 ) = {\sum }_{p , q = 0}^{{N}_{thr} - 1} {g}_{p , q} ( t = 0 ) {x}^{p} {y}^{q} , \qquad ( 8 )$$

where Nₜₕᵣ denotes a truncation threshold and g_{p,q}(t=0) denote the second sequence of expansion coefficients (cf. block 106) that may be considered as ‘transformed’ expansion coefficients that define the quantum operator Â(t=0) in the first function basis, which constitutes the second representation of the quantum operator Â(t=0) referred to above. In this regard, the second sequence of expansion coefficients g_{p,q}(t=0) may be also referred to as transformed expansion coefficients and they may be derived based on the first sequence of expansion coefficients f_{k,l}(t=0) according to

$${g}_{p , q} ( t = 0 ) = {\sum }_{j = 0}^{min ( p , q )} \frac{{r}^{- j}}{j !} {f}_{p - j , q - j} ( t = 0 ) . \qquad ( 9 )$$

The second generating function corresponds to the operator expansion that may be expressed as

$$\hat{A} ( t = 0 ) = {\sum }_{p , q = 0}^{{N}_{thr} - 1} {g}_{p , q} ( t = 0 ) {\hat{T}}_{p , q} , \qquad ( 10 )$$

where the operator basis elements are

$${\hat{T}}_{p , q} = {\sum }_{j = 0}^{∞} \frac{{( - r )}^{- j}}{j !} {\hat{o}}_{1}^{p + j} {\hat{o}}_{2}^{q + j} . \qquad ( 11 )$$

As a background for operations pertaining to block 106, the second representation of the quantum operator Â(t=0) obtained via application of the transformation according to the equation (6) above to its first representation is still a function of multiple non-temporal variables. Consequently, directly solving its respective dynamic equation via usage of numerical methods carried out using one or more classical computers is typically infeasible or even virtually impossible due to excessive requirements on memory usage and processing power.

However, the second representation of the quantum operator Â(t=0) may be decomposed into a linear combination of terms, each comprising a sum of a product of two univariate component functions and a bivariate residual function, which allows for simulating the dynamics of each these terms separately from each other, thereby significantly reducing the memory storage capacity and/or processing power required for the simulation. The third representation of the quantum operator Â(t) obtainable via such a decomposition may be written as

$$\begin{matrix}G ( x , y ; t ) = {\sum }_{p , q = 0}^{{N}_{thr} - 1} {g}_{p , q} ( t = 0 ) {G}^{( p , q )} ( x , y ; t ) \\ = {\sum }_{p , q = 0}^{{N}_{thr} - 1} {g}_{p , q} ( t = 0 ) [ {G}_{x}^{( p )} ( x ; t ) {G}_{y}^{( q )} ( y ; t ) + {R}^{( p , q )} ( x , y ; t ) ] \\ = {\sum }_{p , q = 0}^{{N}_{thr} - 1} {g}_{p , q} ( t = 0 ) [ {\sum }_{k = 0}^{{N}_{{thr}^{- 1}}} {g}_{x , k}^{( p )} ( t ) {x}^{k} {\sum }_{l = 0}^{{N}_{thr} - 1} {g}_{y , l}^{( q )} ( t ) {y}^{l} + \\ {\sum }_{( k , l ) ∈ {S}_{p , q}} {r}_{k , l}^{( p , q )} ( t ) {x}^{k} {y}^{l} ] ,\end{matrix} \qquad ( 12 )$$

where S_{p,q} are sets that contain the indices corresponding to the non-negligible expansion coefficients of the residual functions. By comparing equations (8) and (12) it is evident that the multivariate functions G^{(p,q)}(x, y; t=0) are initially separable. Thus, by solving the linear dynamics of each of these functions G^{(p,q)}(x, y; t=0), it is possible to reconstruct the dynamics of the multivariate generating function G(x, y; t).

In the equation (12) above, the first line may be considered as an intermediate representation that defines the quantum operator Â(t) as a linear combination of multivariate intermediate functions G^{(p,q)}(x, y; t) using the second sequence of expansion coefficients g_{p,q}(t=0), whereas the second line of the equation (12) shows decomposition of each intermediate function into a respective sum of a product of two univariate component functions Gₓ^{(p)}(x; t), G_{y}^{(q)}(y; t) and a multivariate residual function R^{(p,q)}(x, y; t). Moreover, the third line of the equation (12) defines the univariate component functions Gₓ^{(p)}(x;t), G_{y}^{(q)}(y; t) in respective second function bases {x^{k}}ₖ₌₀^{N}^{ₜₕᵣ}⁻¹, {y^{l}}ₗ₌₀^{N}^{ₜₕᵣ}⁻¹ using respective expansion coefficients g_{x,k}^{(p)}(t), g_{y,l}^{(q)}(t) and defines the multivariate residual function R^{(p,q)}(x, y; t) in a respective second function basis {x^{k}y^{l}}_{k,l=0}^{N}^{ₜₕᵣ}⁻¹ using expansion coefficients r_{k,l}^{(p,q)}(t). Herein, the respective expansion coefficients g_{x,k}^{(p)}(t), g_{y,l}^{(q)}(t) of the two univariate component functions and the expansion coefficients r_{k,l}^{(p,q)}(t) of the multivariate residual function may be jointly referred to as the third sequence of expansion coefficients. Moreover, the respective second function bases {x^{k}}ₖ₌₀^{N}^{ₜₕᵣ}⁻¹, {y^{l}}ₗ₌₀^{N}^{ₜₕᵣ}⁻¹ of the two univariate component functions and the second function basis {x^{k}y^{l}}_{k,l=0}^{N}^{ₜₕᵣ}⁻¹ of the multivariate residual function may be jointly referred to as the second function bases, whereas the respective univariate component functions Gₓ^{(p)}(x; t), G_{y}^{(q)}(y; t) and the multivariate residual function R^{(p,q)}(x, y; t) constitute a set of functions time evolution nof which is independent of other related sets of functions.

The component functions and the residual functions are governed by the respective dynamic equations

$$\frac{{dG}_{x}^{( p )} ( x ; t )}{dt} = [ i : H ( x , r {\partial }_{x} ; t ) : + {C}_{p , q} ] {G}_{x}^{( p )} ( x ; t ) , \qquad ( 13 a )$$

$$\frac{{dG}_{y}^{( q )} ( y ; t )}{dt} = - [ i : H ( r {\partial }_{y} , y ; t ) : + {C}_{p , q} ] {G}_{y}^{( q )} ( y ; t ) , \qquad ( 13 b )$$

$$\frac{{dR}^{( p q )} ( x , y ; t )}{dt} = i [ : H ( x , r {\partial }_{x} ; t ) : - : H ( r {\partial }_{y} , y ; t ) : ] {R}^{( p , q )} ( x , y ; t ) + {\sum }_{n} {κ}_{n} {O}_{n}^{′} ( x , {\partial }_{x} , y , {\partial }_{y} , r ) {G}^{( p , q )} ( x , y ; t ) , \qquad ( 13 c )$$

where C_{p,q} are the separation constants. Along the lines described in the foregoing, the dynamic equations according to the equations (13a, 13b, 13c) above serve as a non-limiting example that depends on the choice of the first function basis in the definition of the first generating function F(x, y; t) and a different choice of the first function basis would lead into different forms of the dynamic equations (13a, 13b, 13c).

The equations (13a, 13b, 13c) imply that given sufficiently small κₙT for all n, the residual functions at all time instants, R^{(p,q)}(x, y; t), may either be approximated as zero functions or as functions of only few non-negligible expansion coefficients, given suitable function bases for the residual functions. This further implies that the transformation from the second representation of the quantum operator Â(t) into its third representation enables storing the operator in a memory-efficient manner during the simulation.

Referring now to operations that pertain to block 108, the aspect of determining values of the third sequence of expansion coefficients g_{x,k}^{(p)}(t=T), g_{y,l}^{(q)}(t=T) and r_{k,l}^{(p,q)}(t=T) may involve carrying out numerical simulations based on the third representation of the quantum operator and Â(t=0) by solving the equations (13a) to (13c) via finding the respective values for the third sequence of expansion coefficients. The determination of the values the third sequence of expansion coefficients may proceed from the initial conditions that G^{(p)}(x; t=0)=x^{p} and G^{(q)}(y; t=0)=y^{q} for each non-negligible g_{p,q}(t=0).

As described in the foregoing, the third representation allows for carrying out the simulation based on two or more encoded components. In this regard, the numerical simulation in order to find the respective values for the third sequence of expansion coefficients g_{x,k}^{(p)}(t=T), g_{y,l}^{(q)}(t=T) and r_{k,l}^{(p,q)}(t=T) may be carried out separately and independently of each other

for each of the two component functions Gₓ^{(p)}(x; t), G_{y}^{(q)}(y; t) and the residual function R^{(p,q)}(x, y; t), thereby implementing the numerical simulation via processing two or more encoded components.

Referring now to operations that pertain to block 110, the aspect of deriving the time-evolved values of the first sequence of expansion coefficients f_{k,l}(t=T) via applying the second transformation on the values of the second sequence of expansion coefficients g_{k,l}(t=0) and on the time-evolved values of the third sequence of expansion coefficients g_{x,p}^{(k)}(t=T), g_{y,q}^{(l)}(t=T) and r_{p,q}^{(k,l)}(t=T) to solve dynamics of the quantum operator, i.e. to determine Â(t=T), in the second operator basis. As an example in this regard, the second operator basis may comprise the first operator basis and, consequently, second transformation may convert the second sequence of expansion coefficients and the time-evolved values of the third sequence of expansion coefficients back to the first operator basis, thereby inverting the maps, transformations and decompositions applied in transforming the quantum operator Â(t=0) from the first representation into its third representation, which may be carried out, for example, as

$${f}_{k , l} ( t = T ) = {\sum }_{j = 0}^{min ( k , l )} \frac{{( - r )}^{- j}}{j !} {\sum }_{p , q = 0}^{∞} {g}_{p , q} ( t = 0 ) {g}_{k - j , l - j}^{( p , q )} ( t = T ) , \qquad ( 14 )$$

where g_{k,l}^{(p,q)}(t=T) denote the expansion coefficients of G^{(p,q)}(x, y; t=T) in the chosen function basis {x^{k}y^{l}}_{k.l=0}^{∞}.

In another example, the second operator basis may be a predefined operator basis different from the first operator basis. In such an example the second transformation may serve to invert the transformations and decompositions applied in transforming the quantum operator Â(t=0) from the first representation into its third representation while further converting the second sequence of expansion coefficients and the time-evolved values of the third sequence of expansion coefficients to an operator basis different from the first operator basis.

In general, the approach described in the foregoing requires solving the respective dynamics of (i.e. the respective second expansion coefficients for) Nₜₕᵣ² generating functions, where Nₜₕᵣ denotes the truncation threshold applied for truncation of the Taylor expansion e.g. in the equations (12) above. The required number of generating functions that need to be solved may be reduced to Nₜₕᵣ in scenarios where the initial operator is subdiagonal, superdiagonal or diagonal in the first operator basis, i.e.

$$\hat{A} ( t = 0 ) = {\sum }_{k = max ( 0 , - d )}^{{N}_{thr} - 1} {f}_{k , k + d} ( t = 0 ) {\hat{o}}_{1}^{k} {\hat{o}}_{2}^{k + d} , \qquad ( 15 )$$

where d∈ [symbol] defines whether the initial operator is subdiagonal (d<0), superdiagonal (d>0) or diagonal (d=0). In such a scenario the values of the first sequence of the expansion coefficients may be derived based on the time-evolved values of the third sequence of expansion coefficients, for example, via

$${f}_{k , l} ( t = T ) = {\sum }_{j = 0}^{min ( k , l )} \frac{{( - r )}^{- j}}{j !} {\sum }_{p = max ( 0 , - d )}^{∞} {g}_{p , p + d} ( t = 0 ) {g}_{k - j , l - j}^{( p , p + d )} ( t = T ) . \qquad ( 16 )$$

Non-limiting examples of operators that have this favorable property include the number state projectors, the powers and cumulants of ô₁ô₂, the operator defining the leakage error from a subspace spanned by number states, and the squeezing operator.

As pointed out above, the examples described in the foregoing predominantly describe simulation of a bosonic quantum system that includes a single subsystem (e.g. a single mode), where the simulation may proceed from the first representation (cf. block 102) and the second representation (cf. block 104) defining the quantum operator Â(t) in the first operator basis and in the first function basis, respectively, that each comprise two elements with the third representation (cf. block 106) defining the quantum operator Â(t) via a linear combination of terms that each comprise a sum of a product of two univariate component functions and a bivariate residual function. The examples described in the foregoing, however, readily generalize into simulation of a bosonic quantum subsystem that involves M subsystems (e.g. M modes), where M (implicitly) denotes an integer that is larger than or equal to one. In this regard, the simulation may proceed from the first representation (cf. block 102) and the second representation (cf. block 104) defining the quantum operator Â(t) in the first operator basis and in the first function basis, respectively, that each comprise 2M elements with the third representation (cf. block 106) defining the quantum operator Â(t) via a linear combination of terms that each comprise a sum of a product of two M-variate component functions and a 2M-variate residual function.

The simulation of the quantum operator in accordance with the model depicted in FIG. 1 via operation of the method 100 may be carried out in a number of different ways either by a single entity that implements the encoding, the simulation and the decoding (cf. blocks 102 to 110) or by two separate entities where a first entity implements the encoding and the simulation (cf. blocks 102 to 108) and second entity implements the decoding (cf. block 110). In the latter scenario, the first entity may transmit the simulations results obtained via the encoded domain simulation to the second entity for decoding therein. The simulation according to the method 100 may be accomplished, for example, according to one of the examples described with references to FIGS. 3A to 3C.

FIG. 3A depicts a block diagram that illustrates an example in this regard, where the encoder 10, the simulator 20 and the decoder 30 may be co-located, e.g. implemented by the same apparatus, and where the simulation of the respective dynamics of the two or more independent sets of functions (cf. block 108) may be carried out in a successive manner (e.g. in series) via respective simulator portions 20-1, 20-2, . . . , 20-J. Such an approach allows for reducing memory required for carrying the simulation while it may result in increasing the time required for simulation (in comparison to a scenario where the two or more independent sets of functions are processed in parallel).

FIG. 3B depicts a block diagram that illustrates another example of implementing the model of FIG. 1, where the encoder 10, the simulator 20 and the decoder 30 may be co-located (e.g. implemented by the same apparatus) and where the simulation of the respective dynamics of the two or more independent sets of functions (cf. block 108) may be carried out simultaneously (e.g. in parallel) via the respective simulator portions 20-1, 20-2, . . . , 20-J. Such an approach allows for reduced simulation time while it may result in an increased memory requirement (in comparison to a scenario where the two or more independent sets of functions are processed in series).

In a further example, the encoder 10 and the simulator 20 may be co-located in a first location, whereas the decoder may be provided in a second location that is different from the first location and it may be communicatively coupled to the first location via a communication link or a communication network. As an example, in this regard, the encoder 10 and the simulator 20 may be implemented by a first apparatus while the decoder may be implemented by a second apparatus, where the first and second apparatuses each include a respective communication portion to enable communicative coupling between the first and second apparatuses via the communication link or the communication network. In such an approach, the simulation of the respective dynamics of the two or more independent sets of functions (cf. block 108) may be carried out via the respective simulator portions 20-1, 20-2, . . . , 20-J and the respective simulation results of the simulation portions 20-1, 20-2, . . . , 20-J may be transmitted from the first apparatus to the second apparatus for decoding therein. In an example, the simulation of the respective dynamics of the two or more independent sets of functions (cf. block 108) may be carried out successively (e.g. in series), whereas in another example the simulation of the respective dynamics of the two or more independent sets of functions may be carried substantially simultaneously (e.g. in parallel). Without losing generality, the first apparatus may be referred to as an encoder apparatus and the second apparatus may be referred to as a decoder apparatus.

The simulation technique described via various examples of the present disclosure enables simulating a quantum computer implementing a certain quantum algorithm using one or more classical computers enable simulation of quantum algorithms of different complexities. In particular, the simulation carried out in the encoded domain via simulating respective dynamics of the two or more independent sets of functions instead of directly simulating dynamics of the multivariate classical function enables shortening the simulation time and/or reducing memory requirement of the simulation in comparison to previously known simulation methods. Consequently, the disclosed simulation technique is also applicable for optimization of control of the quantum processor for maximizing the accuracy in performing the quantum algorithm under consideration and/or verification of the quantum processor and/or the quantum algorithm under consideration also for quantum algorithms of high complexity (in terms of memory requirement and/or processing load).

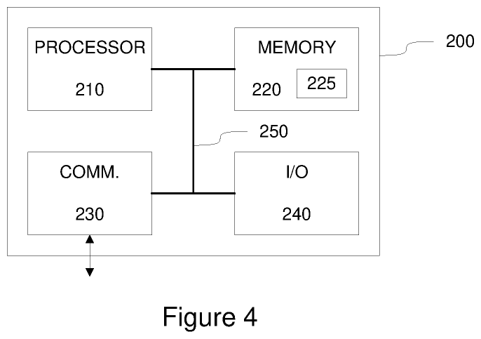

FIG. 4 illustrates a block diagram of some components of an apparatus 200 that may be employed to implement at least some of the operations described in the foregoing with references to encoder 10, the simulator 20, the decoder 30 and the method 100. In one example, the apparatus 200 may be employed to implement one or more of the encoder 10, the simulator 20 and the decoder 30, whereas in another example the apparatus 200 may be employed to implement one or more (e.g. all) steps of the method 100 described in the foregoing. The apparatus 200 comprises a processor 210 and a memory 220. The memory 220 may store data and computer program code 225. The apparatus 200 may further comprise communication means 230 for wired or wireless communication with other apparatuses and/or user I/O (input/output) components 240 that may be arranged, together with the processor 210 and a portion of the computer program code 225, to provide the user interface for receiving input from a user and/or providing output to the user. In particular, the user I/O components may include user input means, such as one or more keys or buttons, a keyboard, a touchscreen or a touchpad. The user I/O components may include output means, such as a display or a touchscreen. The components of the apparatus 200 are communicatively coupled to each other via a bus 250 that enables transfer of data and control information between the components.

The memory 220 and a portion of the computer program code 225 stored therein may be further arranged, with the processor 210, to cause the apparatus 200 to perform at least some aspects of operation of the encoder 10, the simulator 20 and/or the decoder 30 or to implement one or more steps of the method 100. The processor 210 is configured to read from and write to the memory 220. Although the processor 210 is depicted as a respective single component, it may be implemented as respective one or more separate processing components. Similarly, although the memory 220 is depicted as a respective single component, it may be implemented as respective one or more separate components, some or all of which may be integrated/removable and/or may provide permanent/semi-permanent/dynamic/cached storage.

The computer program code 225 may comprise computer-executable instructions that implement at least some aspects of operation of the encoder 10, the simulator 20 and/or the decoder 30 or that implement one or more steps of the method 100 when loaded into the processor 210. As an example, the computer program code 225 may include a computer program consisting of one or more sequences of one or more instructions. The processor 210 is able to load and execute the computer program by reading the one or more sequences of one or more instructions included therein from the memory 220. The one or more sequences of one or more instructions may be configured to, when executed by the processor 210, cause the apparatus 200 to perform at least some aspects of operation of the encoder 10, the simulator 20 and/or the decoder 30 or to implement one or more steps of the method 100. Hence, the apparatus 200 may comprise at least one processor 210 and at least one memory 220 including the computer program code 225 for one or more programs, the at least one memory 220 and the computer program code 225 configured to, with the at least one processor 210, cause the apparatus 200 to perform at least some aspects of operation of the encoder 10, the simulator 20 and/or the decoder 30 or to implement one or more steps of the method 100.

The computer program code 225 may be provided e.g. as a computer program product comprising at least one computer-readable non-transitory medium having the computer program code 225 stored thereon, which computer program code 225, when executed by the processor 210 causes the apparatus 200 to perform at least some aspects of operation of the encoder 10, the simulator 20 and/or the decoder 30 or to implement one or more steps of the method 100. The computer-readable non-transitory medium may comprise a memory device, a record medium or another article of manufacture that tangibly embodies the computer program. As another example, the computer program may be provided as a signal configured to reliably transfer the computer program.

Reference(s) to a processor herein should not be understood to encompass only programmable processors, but also dedicated circuits, such as field-programmable gate arrays (FPGA), application-specific integrated circuits (ASIC) and signal processors. Features described in the preceding description may be used in combinations other than the combinations explicitly described.

1. A method (100) for simulating a quantum operator of a bosonic quantum system, the method (100) comprising:
obtaining (102) a first representation that defines the quantum operator in a first operator basis using a first sequence of expansion coefficients;
transforming (104), via applying a first transformation on the first sequence of expansion coefficients, the first representation into a second representation that defines the quantum operator in a first function basis using a second sequence of expansion coefficients;
decomposing (106) the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients;
determining (108) time-evolved values of the third sequence of expansion coefficients based on the third representation, thereby determining time-evolved independent sets of functions represented in the second function bases; and
determining (110) time-evolved values of the first sequence of expansion coefficients via applying a second transformation on the second sequence of expansion coefficients and on the time-evolved third sequence of expansion coefficients to determine the time-evolved quantum operator in a second operator basis.

2. A method (100) according to claim 1, wherein the first representation and the second representation define the quantum operator in the first operator basis and in the first function basis, respectively, that each comprise 2M elements, and
the third representation defines the quantum operator via a linear combination of terms that each comprise a sum of a product of two M-variate component functions and a 2M-variate residual function,
where M denotes an integer that is larger than or equal to one.

3. A method (100) according to claim 2, wherein the first and the second representation define the quantum operator in the first operator basis and in the first function basis, respectively, that each comprise two elements and wherein said decomposing (106) comprises:
converting the second representation into an intermediate representation that defines the quantum operator as a linear combination of bivariate intermediate functions using the second sequence of expansion coefficients;
decomposing each of said bivariate intermediate functions into a respective sum of a product of respective two univariate component functions and a respective bivariate residual function; and
converting said univariate component functions and the bivariate residual function into a representation that defines each of said univariate component functions and said bivariate residual functions in a respective second function basis using the third sequence of expansion coefficients, thereby obtaining the third representation of the quantum operator.

4. A method (100) according to claim 2, wherein said decomposing (106) comprises:
converting the second representation into an intermediate representation that defines the quantum operator as a linear combination of 2M-variate intermediate functions using the second sequence of expansion coefficients;
decomposing each of said 2M-variate intermediate functions into a respective sum of a product of respective two M-variate component functions and a respective 2M-variate residual function; and
converting said M-variate component functions and the 2M-variate residual function into a representation that defines each of said M-variate component functions and said 2M-variate residual functions in a respective second function basis using the third sequence of expansion coefficients, thereby obtaining the third representation of the quantum operator.

5. A method according to any of claims 2 to 4, wherein said decomposing (106) comprises estimating at least one of said residual functions as a zero function.

6. A method (100) according to any of claims 1 to 5, wherein the initial value of the quantum operator is subdiagonal, superdiagonal or diagonal in the first operator basis.

7. A method (100) according to any of claims 1 to 6, wherein the first representation defines the quantum operator as a sum of respective monomials of two or more elementary operators multiplied by respective coefficients of the first sequence of expansion coefficients.

8. A method (100) according to any of claims 1 to 7, wherein the second representation defines the quantum operator as a sum of respective monomials of two or more elementary functions multiplied by respective coefficients of the first sequence of expansion coefficients.

9. A method (100) according to any of claims 1 to 8, wherein the predefined first transformation comprises an automorphism.

10. A method (100) according to any of claims 1 to 9, wherein the predefined second transformation is arranged to convert the second sequence of expansion coefficients and the time-evolved third sequence of expansion coefficients into the first operator basis, thereby determining the time-evolved quantum operator in the first operator basis.

11. A method (100) according to any of claims 1 to 10, wherein determining (108) the time-evolved values of the third sequence of expansion coefficients based on the third representation comprises carrying out one or more numerical simulations based on the third representation of the quantum operator.

12. A method (100) according to any of claims 1 to 11, comprising determining (108) the respective time-evolved values of the third sequence of expansion coefficients for each of the independent sets of functions separately from each other.

13. A method (100) according to claim 12, wherein the respective time-evolved values of the third sequence of expansion coefficients for each of the independent sets of functions are derived substantially in a successive manner.

14. A method (100) according to claim 12, wherein the respective time-evolved values of the third sequence of expansion coefficients for each of the independent sets of functions are derived substantially simultaneously.

15. A method (100) for simulating a quantum operator of a bosonic quantum system, the method (100) comprising:
obtaining (102) a first representation that defines the quantum operator in a first operator basis using a first sequence of expansion coefficients;
transforming (104), via applying a first transformation on the first sequence of expansion coefficients, the first representation into a second representation that defines the quantum operator in a first function basis using a second sequence of expansion coefficients;
decomposing (106) the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients; and
determining (108) time-evolved values of the third sequence of expansion coefficients based on the third representation, thereby determining time-evolved independent sets of functions represented in the second function bases.

16. A method (100) for simulating a quantum operator of a bosonic quantum system, the method (100) comprising:
receiving respective values of time-evolved values of a second sequence of expansion coefficients and a third sequence of expansion coefficients,
wherein said time-evolved values of the third sequence of expansion coefficients are determined based on a third representation of a quantum operator that is obtained via decomposing a second representation of the quantum operator into the third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using the third sequence of expansion coefficients, and
wherein the second representation defines the quantum operator in a first function basis using the second sequence of expansion coefficients, wherein the second representation is obtained via applying a first transformation on a first sequence of expansion coefficients of a first representation of the quantum operator that defines the quantum operator in a first operator basis using the first sequence of expansion coefficients; and
determining (110) time-evolved values of the first sequence of expansion coefficients via applying a second transformation on the second sequence of expansion coefficients and on the time-evolved third sequence of expansion coefficients to determine the time-evolved quantum operator in a second operator basis.

17. A method according to claim 15 or 16, wherein
the first representation and the second representation define the quantum operator in the first operator basis and in the first function basis, respectively, that each comprise 2M elements, and
the third representation defines the quantum operator via a linear combination of terms that each comprise a sum of a product of two M-variate component functions and a 2M-variate residual function,
where M denotes an integer that is larger than or equal to one.

18. A computer program comprising instructions for causing one or more apparatuses to perform at least the method (100) according to any of claims 1 to 17.

19. An apparatus (200) comprising at least one processor (210) and at least one memory (220) including computer program code (225) for one or more computer programs, wherein the at least one memory (220) and the computer program code (225) are configured to, with the at least one processor (210), cause the apparatus (200) to perform the method according to any of claims 1 to 17.

20. A system comprising:
an encoder (10) arranged to:
obtain a first representation that defines the quantum operator in a first operator basis using a first sequence of expansion coefficients, transform, via applying a first transformation on the first sequence of expansion coefficients, the first representation into a second representation that defines the quantum operator in a first function basis using a second sequence of expansion coefficients, and
decompose the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients;
a simulator (20) arranged to determine time-evolved values of the third sequence of expansion coefficients based on the third representation, thereby determining time-evolved independent sets of functions represented in the second function bases; and
a decoder (30) arranged to determine time-evolved values of the first sequence of expansion coefficients via applying a second transformation on the second sequence of expansion coefficients and on the time-evolved third sequence of expansion coefficients to determine the time-evolved quantum operator in a second operator basis.

21. An encoder apparatus comprising:
an encoder (10) arranged to:
obtain a first representation that defines the quantum operator in a first operator basis using a first sequence of expansion coefficients, transform, via applying a first transformation on the first sequence of expansion coefficients, the first representation into a second representation that defines the quantum operator in a first function basis using a second sequence of expansion coefficients, and
decompose the second representation into a third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using a third sequence of expansion coefficients;
a simulator (20) arranged to determine time-evolved values of the third sequence of expansion coefficients based on the third representation, thereby determining time-evolved independent sets of functions represented in the second function bases; and
a communication portion arranged to transmit the second sequence of expansion coefficients and the time-evolved values of the third sequence of expansion coefficients to another apparatus.

22. A decoder apparatus comprising:
a communication portion for receiving, from another apparatus, respective values of a second sequence of expansion coefficients and time-evolved values of a third sequence of expansion coefficients,
wherein said time-evolved values of the third sequence of expansion coefficients are determined based on a third representation of a quantum operator that is obtained via decomposing a second representation of the quantum operator into the third representation that defines the quantum operator as a linear combination of terms that each comprise a sum of a product of two component functions and a residual function using the second sequence of expansion coefficients, wherein the two component functions and the residual function of each term constitute a respective independent set of functions and are represented in second function bases using the third sequence of expansion coefficients, and
wherein the second representation defines the quantum operator in a first function basis using the second sequence of expansion coefficients, wherein the second representation is obtained via applying a first transformation on a first sequence of expansion coefficients of a first representation of the quantum operator that defines the quantum operator in a first operator basis using the first sequence of expansion coefficients; and
a decoder (30) arranged to determine time-evolved values of the first sequence of expansion coefficients via applying a second transformation on the second sequence of expansion coefficients and on the time-evolved third sequence of expansion coefficients to determine the time-evolved quantum operator in a second operator basis.

23. A system according to claim 20, an encoder apparatus according to claim 21 or a decoder apparatus according to claim 22, wherein
the first representation and the second representation define the quantum operator in the first operator basis and in the first function basis, respectively, that each comprise 2M elements, and
the third representation defines the quantum operator via a linear combination of terms that each comprise a sum of a product of two M-variate component functions and a 2M-variate residual function,
where M denotes an integer that is larger than or equal to one.
